(19) United States
(12) Patent Application Publication
(10) Pub. No.: US 2014/0338292 A1
(43) Pub. Date: Nov. 20, 2014

(54) SLING FOR SUPPORTING A SADDLE

(71) Applicant: Neal Abel, Middleburg, FL (US)

(72) Inventor: Neal Abel, Middleburg, FL (US)

(21) Appl. No.: 13/893,931

(22) Filed: May 14, 2013

(51) Int. Cl. B68C 1/00; B68C 1/02

(52) U.S. Cl. CPC B68C 1/002; B68C 1/02
USPC 54/44.1; 54/84

(57) ABSTRACT

A saddle sling for supporting a saddle against a vertical support such as a fence post includes a hook (e.g., C-, V-, U- or L-shaped hook) configured to engage a cantle or pommel edge of a saddle (i.e., an equestrian saddle). The hook defines a gap into which the engaged edge of the saddle is received. A tether loop extends from the hook. The loop is sufficiently long to extend from the engaged edge past the opposite edge and over a vertical support, such as a fence post or picket. The loop may be fixed, adjustable or retractable. The saddle is thus held between the hook and the fence or fence post.

### FIELD OF THE INVENTION

This invention relates generally to horse saddles, and, more particularly, to a sling for holding a saddle against a vertical support structure, such as, but not limited to a fence.

### BACKGROUND

Equestrians often jealously guard their saddles because they are expensive, ornate, prized possessions. Many saddles are hand crafted of fine leather adorned with precious metal ornamentation. Concomitantly, stable grounds are typically littered with debris and waste, including fecal matter. Unfortunately, the leather is easily stained and fouled with fetid waste. Thus, riders and stable operators must take care to keep their prized saddles off the ground.

Additionally, leather saddles may lose their preferred shape when stored improperly. For example, a saddle carelessly left on the ground may collapse, contract and stiffen. An uneven, creased or lumpy saddle panel causes discomfort to a horse and may lead to a sore back and another more serious back problem. Additionally, restoration of a deformed saddle may take considerable time, effort and expense.

To protect and preserve saddles, equestrians have developed various saddle racks. Many saddle racks consist of one or more legs supporting a base framework. Some racks are mounted to a vertical support such as a wall or post. The base framework includes a plurality of bars that provide a support surface roughly approximating the torso (i.e., back loin and flank) of a horse. While such devices are effective for safely storing a saddle, they are not compact or easily stowable or portable.

When travelling with a horse or horses the amount or tack (saddle) and other material is considerable and burdensome. Each rider has a tack truck for each horse that accompanies the horse in travel. They also must take feed, grooming brushes, tack cleaner, horse health remedies, blankets for to cover the horse, shipping boats (horse wear boots in the trailer to protect the horse's legs), girth for the saddle, grooming clippers, rider's helmet (both schooling and show helmets), hoof shine, shampoo and conditioner. A bulky heavy saddle holder would only add to the burden of travelling.

What is needed is a compact, collapsible temporary saddle support. The support should be relatively inexpensive, lightweight, and easy-to-use, and fit into a standard backpack or duffel bag, and support a wide range of saddles.

The invention is directed to overcoming one or more of the problems and solving one or more of the needs as set forth above.

### SUMMARY OF THE INVENTION

To solve one or more of the problems set forth above, in an exemplary implementation of the invention, a saddle sling is provided. The sling includes a saddle hook attached to a tether loop. The hook comprises a generally L-shaped, C-shaped, U-shaped, or V-shaped body sized to receive an edge of the saddle.

The tether, which is attached to the hook, may be comprised of rope, chain, cable, rawhide or other flexible strand. The tether may be retractable and extendable, or fully extended. The saddle hook engages one end of the saddle. The tether forms a loop that is sufficiently long to extend beneath the saddle, past the end that is opposite the end engaged by the hook by a sufficient distance to extend around, and thereby engage, a vertical or horizontal support. The vertical pole may be a fence post and the horizontal support could be a fence rail or section of chain link fence

The hooked saddle is thus held against the vertical support by the saddle sling. The tether passing beneath the saddle provides a framework to support the saddle and resist deformation. The saddle is thus kept off the ground.

To release the saddle, the loop is removed from the vertical support. Then the hook disengages the saddle. The sling may then be folded and stored in an ordinary backpack, duffel bag or other storage device.

The saddle hook may be personalized with ornamentation, such as a bust of a horse, and/or markings. By way of example and not limitation, the markings may include the owner's identification.

Thus, in an exemplary saddle sling for supporting a saddle against a vertical support such as a fence post, the sling includes a hook configured to engage a cantle or pommel edge of a saddle (i.e., an equestrian saddle). That edge is referred to as the engaged edge of the saddle. The hook includes a first segment that extends below the saddle at the engaged edge and a second segment that is attached to the first segment and extends above the engaged edge of the saddle. Thus, the hook defines a gap into which the engaged edge of the saddle is received. A tether loop extends from the hook. The loop has a proximal end attached to the hook and an opposite distal end a distance from the proximal end. The distance is sufficient to allow the tether loop to pass under the saddle from the engaged end to past the opposite edge by a sufficient additional distance for the distal end of the tether loop to slip over and engage a vertical support.

The tether loop is comprised of a flexible elongated structure. Nonlimiting examples include cordage, filament (e.g., fishing line), cable, chain and rawhide. The tether loop may be fixed length, adjustable length and/or retractable.

The hook may comprise a C-shaped, U-shaped, L-shaped or V-shaped body, by way of example and not limitation. A leg of the body may have a channel or other opening to engage a horn of a saddle, for saddles equipped with horns and hooks configured to engage the pommel edge.

In a retractable embodiment, the hook includes an interior compartment that houses a rotatable spool onto which a tether comprising the tether loop is wound. The spool may be spring biased to rotate in a direction to cause refraction of the tether. A disc (e.g., flywheel) having a toothed outer edge attached may be concentrically attached to the spool. A user-actuable pawl is configured to engage the toothed outer edge and resist rotation when the pawl is not engaged and release the toothed outer edge and permit rotation when the pawl is released. A manual switch may be operably coupled to the pawl. The manual switch extends outwardly from the hook and is manually actuated by a user. The manual switch releases the pawl when the manual switch is actuated and allows the pawl to engage the toothed outer edge when the manual switch is not actuated.

In use the distal end of the tether loop is slipped over and engages a free upper end of a fence post, which may be part of a fence. A saddle with either an engaged pommel edge or engaged cantle edge is held between the hook and the fence or fence post.

In certain embodiments the hook may be a part of an ornament or an ornament may be attached to the hook. By way of example and not limitation, the ornament may be a bust of a horse.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a plan view of an exemplary saddle sling according to principles of the invention; and

FIG. 2 is a top perspective view of an exemplary saddle sling according to principles of the invention; and

FIG. 3 is a side view of an exemplary saddle sling according to principles of the invention; and

FIG. 4 is a plan view of an exemplary saddle sling engaging a saddle according to principles of the invention; and

FIG. 5 is a side view of an exemplary saddle sling engaging a saddle according to principles of the invention; and

FIG. 6 is a side view of an exemplary saddle sling engaging a saddle suspended from a fence according to principles of the invention; and

FIG. 7 is a front view of an exemplary saddle sling engaging a saddle suspended from a fence according to principles of the invention; and

FIG. 8 is a top perspective view of an exemplary saddle sling engaging a saddle suspended from a fence according to principles of the invention; and

FIG. 9 is another top perspective view of an exemplary saddle sling engaging a saddle suspended from a fence according to principles of the invention; and

FIG. 10 is another top perspective view of an exemplary saddle sling engaging a saddle suspended from another fence according to principles of the invention; and

FIG. 11 is a plan view of an alternative exemplary saddle sling according to principles of the invention; and

FIG. 12 is a top perspective view of an alternative exemplary saddle sling according to principles of the invention; and

FIG. 13 is a side view of an alternative exemplary saddle sling according to principles of the invention; and

FIG. 14 is a plan view of another alternative exemplary saddle sling according to principles of the invention; and

FIG. 15 is a top perspective view of another alternative exemplary saddle sling according to principles of the invention; and

FIG. 16 is a side view of another alternative exemplary saddle sling according to principles of the invention; and

FIG. 17 is a side view of an exemplary saddle sling with a decorative element according to principles of the invention; and

FIG. 18 is a top perspective view of another alternative exemplary saddle sling according to principles of the invention; and

FIG. 19 is a side view of another alternative exemplary saddle sling according to principles of the invention; and

FIG. 20 is a top perspective view of another alternative exemplary saddle sling according to principles of the invention; and

FIG. 21 is a top perspective view of a spool assembly for the alternative exemplary saddle sling of FIG. 20 according to principles of the invention; and

FIG. 22 is a plan view of an exemplary saddle sling with saddle supports according to principles of the invention; and

FIG. 23 is a top perspective view of an exemplary saddle sling with saddle supports according to principles of the invention; and

FIG. 24 is a side view of an exemplary saddle sling with saddle supports according to principles of the invention; and

FIG. 25 is a plan view of an exemplary saddle sling with saddle supports according to principles of the invention; and

FIG. 26 is a side view of an exemplary saddle sling with saddle supports according to principles of the invention; and

FIG. 27 is a top perspective view of an exemplary saddle sling with saddle supports according to principles of the invention; and

FIG. 28 is a plan view of an exemplary saddle sling with saddle supports according to principles of the invention; and

FIG. 29 is a side view of an exemplary saddle sling with saddle supports according to principles of the invention; and

FIG. 30 is a top perspective view of an exemplary saddle sling with saddle supports according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

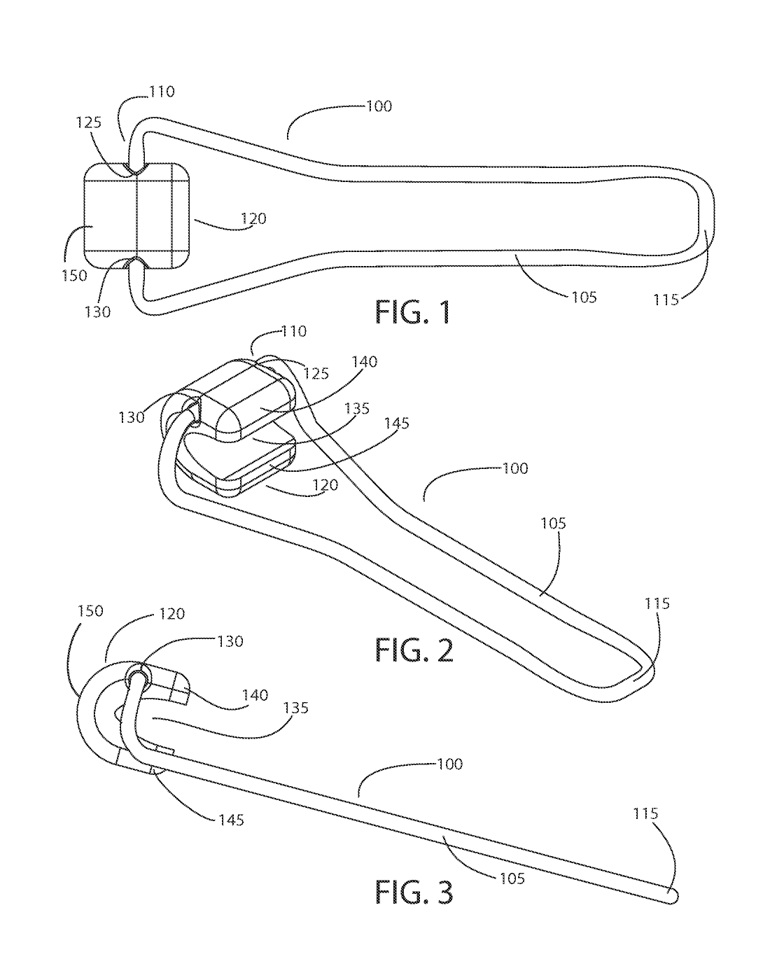

Referring to FIGS. 1-3, various views of an exemplary saddle sling 100 according to principles of the invention are shown. The saddle sling 100 includes an elongated tether loop 105. The loop 105 is longer than the length of a saddle. The distal end 115 of the loop 105 (i.e., the end of the loop 105 opposite from the hook 120) extends over and engages a vertical support, as described below. The proximal end 110 of the loop 105 attaches to the hook 120. The distance between the proximal 110 and distal 115 ends is preferably greater than the length of a saddle (e.g., measured from pommel to cantle) by about six (6) inches. Thus, a 30 to 36 inch loop length is preferred. Such a length accommodates many saddles and vertical supports. An oversized length may be cut and tied to a desired size to accommodate a particular saddle. In another embodiment, the tether loop 105 may be retractable to accommodate a wide range of sizes.

The tether loop 105 is comprise of a flexible strand-like material, such as wire, cable, rope, filament (e.g., fishing line), other cordage, chain, rawhide, or the like. In a preferred embodiment, the tether loop 105 is lightweight, flexible, aesthetically pleasing and unlikely to damage an engaged vertical support. The tether loop 105 may be comprised of a single strand or multiple strands.

The hook 120 is attached to an end (e.g., the proximal end 110) of the tether loop 105. The hook 120 comprises a body configured to engage an edge of a saddle. In a preferred embodiment, the hook engages the edge of the saddle at the pommel, which is the front, slightly raised area of the saddle. Alternatively, the hook may engage the edge at the cantle, which is the back of the saddle. If the saddle has a horn, a hook that engages the edge at the pommel may be configured to avoid or engage the horn. An embodiment that engages the horn is described below.

In the hook 120 embodiment shown in FIGS. 1 through 3 the hook generally resembles a C or a U, with a pair of generally parallel legs 140, 145 connected by a curved joint 150. A gap 135 is defined between the legs 140, 145. The width of the gap 135 at the opening (i.e., the distance between the legs 140, 145 at the opening) is greater than the thickness of the engaged edge of the saddle. Thus, the edge of the saddle may fit into the gap 135 of the hook. Such an edge is engaged by the hook 120 when the edge is within the gap 135. The gap 135 may taper towards the vertex. Thus, the edge may be wedged into the gap 135.

A channel extends through the hook from an opening 125 in one side to an opening 130 in the opposite side. The channel has a diameter that is sufficient to receive a length of the tether loop 105. Means for attaching the tether loop 105 other than a channel may be provided without departing from the scope of the invention. By way of example and not limitation, a pair of eyelets or the like may be attached the hook 120, to which the free ends of a tether may be attached, thereby forming a loop.

The hook 120 is not limited to any particular material, except that the chosen material should exhibit sufficient durability to serve as a saddle supporting hook. In an exemplary embodiment plastic is used to form the hook 120, preferably a substantially strong, solid, yet lightweight material. By way of example and not limitation, the hook 120 may be comprised of polyvinyl chloride (PVC). However, other plastics, wood, composites or a metal such as steel, stainless steel, aluminum, an alloy or some other metal may be used. Other exemplary plastics include nylon, silicone, polysulfone, polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates and/or polyesters. Preferably the chosen material is relatively inexpensive, produces a durable and strong product, is easy to use in manufacturing operations and results in an aesthetically acceptable product. The material may further include additives to provide desired properties such as desired colors, structural characteristics, and phosphorescent or glow-in-the dark properties.

The hook 120 may be produced using any suitable manufacturing techniques known in the art for the chosen material, such as (for example) injection, compression, structural foam, blow, or transfer molding; polyurethane foam processing techniques; vacuum forming; casting; machining; milling; and extrusion. Preferably the manufacturing techniques are suitable for mass production at relatively low cost per unit, and results in an aesthetically acceptable product with a consistent acceptable quality and structural characteristics.

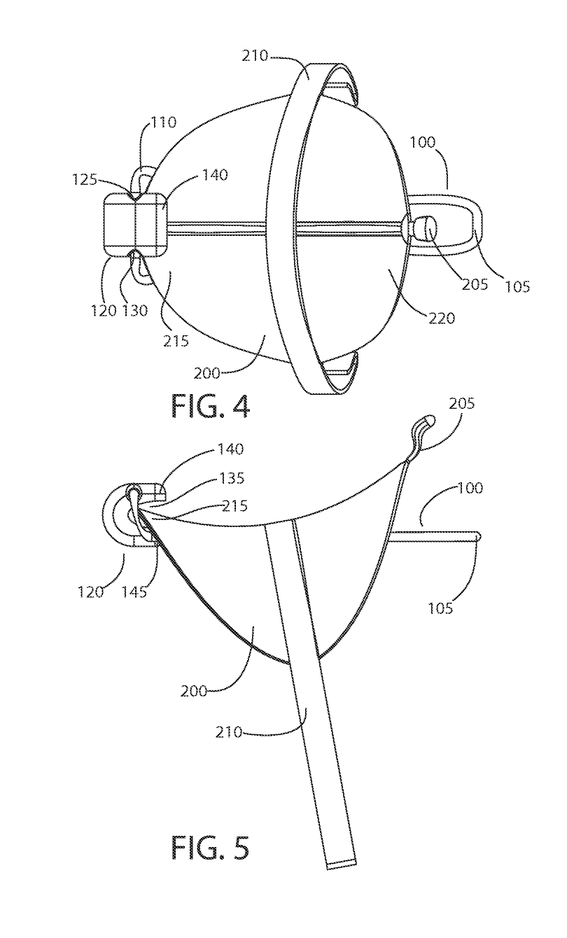

Referring now to FIGS. 4 and 5, an exemplary saddle sling engaging a saddle according to principles of the invention is conceptually illustrated. The depicted saddle 200 represents is a not limiting example of a wider range of saddles, as the invention is not limited to any particular type of saddle. The horn 205 of the exemplary saddle 200 is at the pommel. The edge of the cantle 215, which is the back of the saddle, is engaged by the hook 120. Straps 210 conceptually represent the leather straps connecting stirrups to the saddle tree.

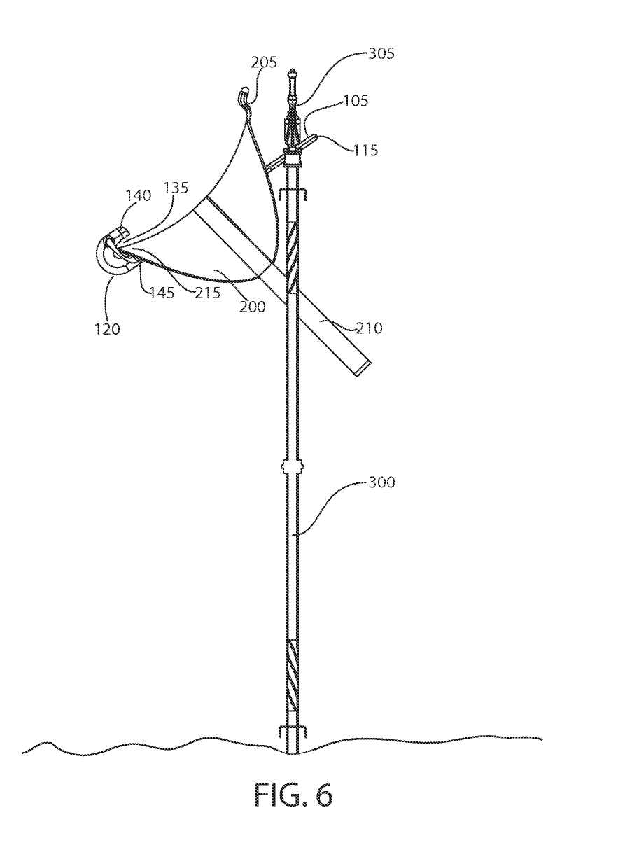

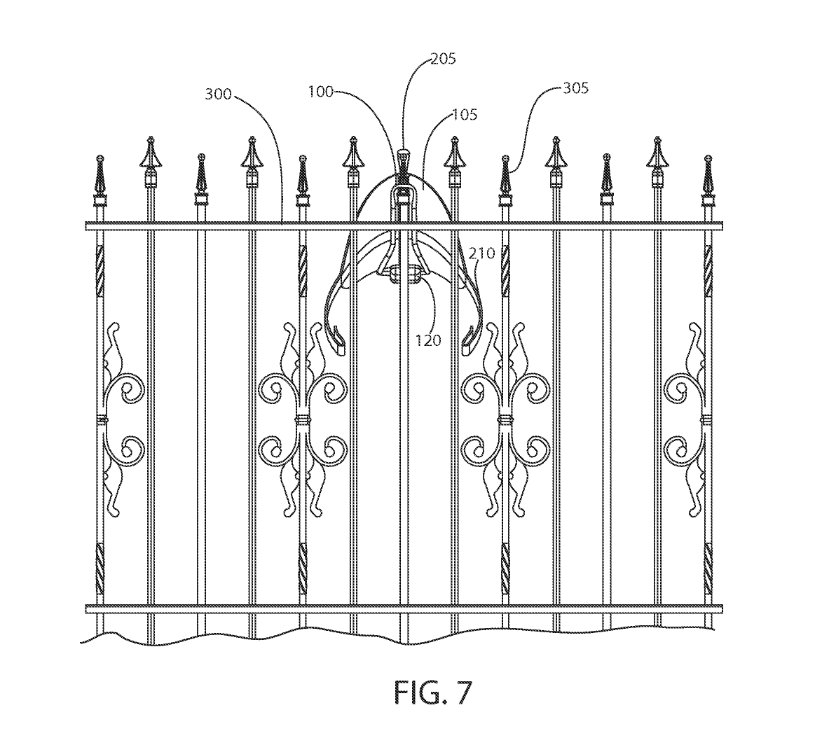

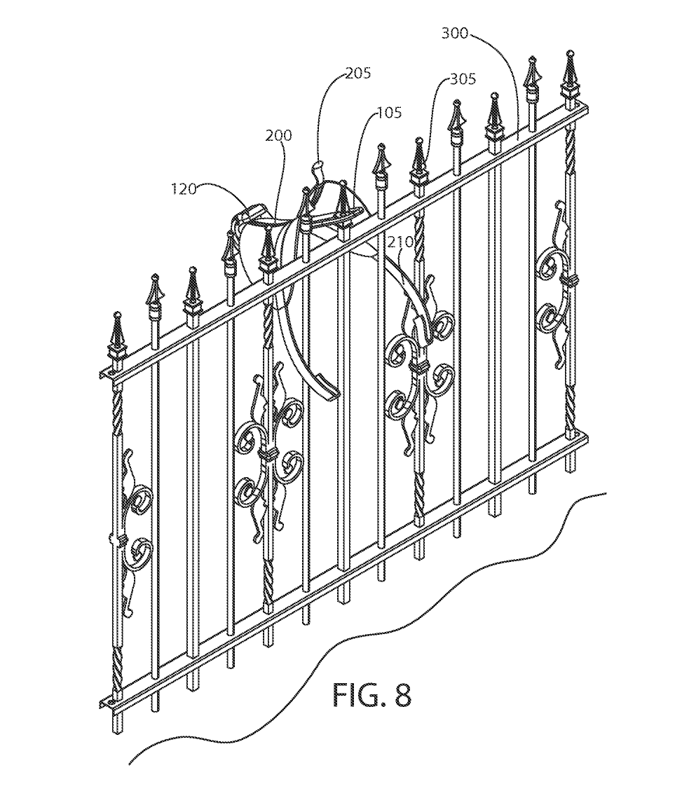

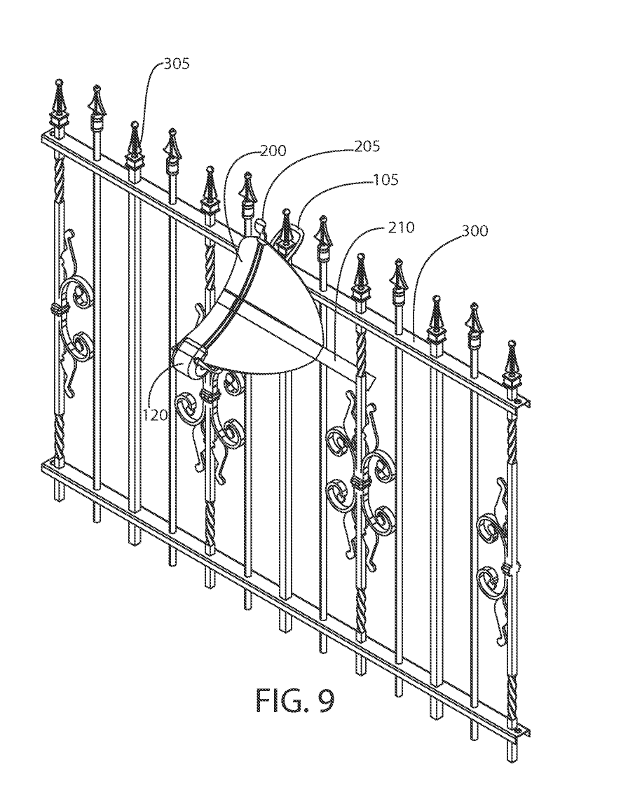

In FIGS. 6 through 9, the sling 100 is shown holding a saddle 200 against a wrought iron fence 300. The distal end 115 of the loop 105 slips over a vertical post 305. The hook 120 prevents the saddle from falling to the ground. The loop 105 keeps the saddle against the fence 300.

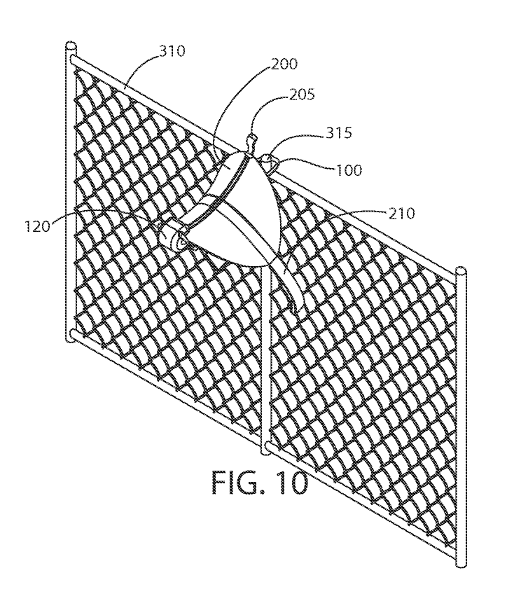

The invention may be used with any fence that has a vertical support such as a fence post over which the distal end of the loop 105 may be slipped. The invention is not limited to wrought iron, picket, stockade, chain link, or other type of fence. Preferably the fence is sufficiently low to the ground for a user to reach the top of the vertical support. Illustratively, FIG. 10 conceptually illustrates the sling 100 holding the saddle 200 against a chain link fence 310. The distal end 115 of the loop 105 slips over a vertical post 315. The hook 120 prevents the saddle from falling to the ground. The loop 105 keeps the saddle against the fence 310.

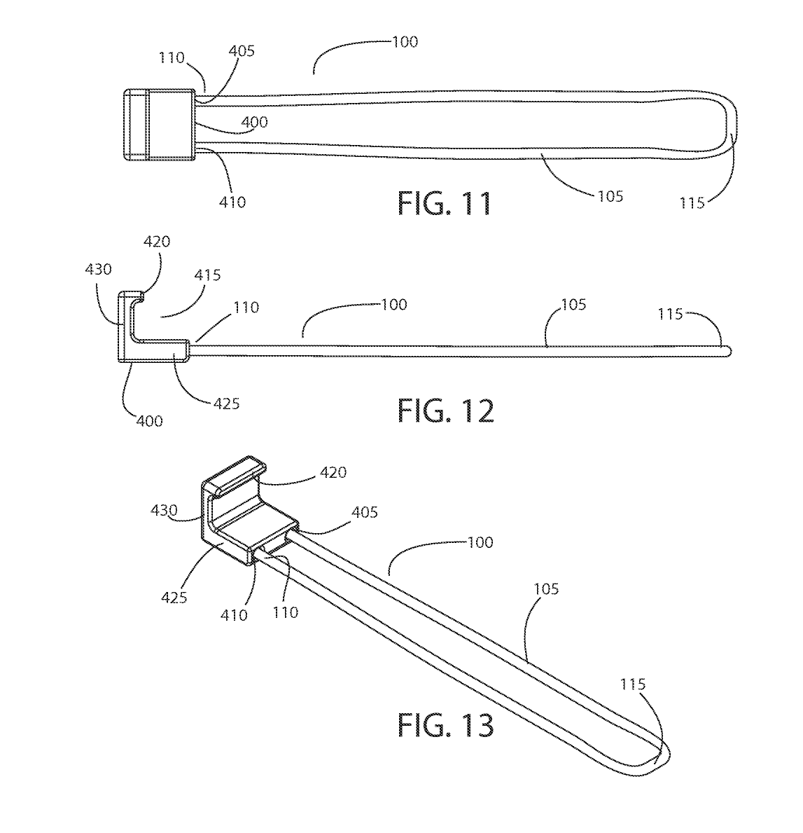

In FIGS. 11 through 13, an alternative exemplary hook 400 is illustrated. The hook 400 is attached to an end (e.g., the proximal end 110) of the tether loop 105. The hook 400 comprises a body configured to engage an edge of a saddle. The hook 400 generally resembles an L, with a pair of generally perpendicular legs 425, 430 with a terminal flange 420. A gap 415 is defined between the leg and flange 420, 425. The width of the gap 415 at the opening (i.e., the distance between the leg and flange 420, 425 at the opening) is greater than the thickness of the engaged edge of the saddle. Thus, the edge of the saddle may fit into the gap 415 of the hook. Such an edge is engaged by the hook 400 when the edge is within the gap 415.

A curved (e.g., U-shaped) channel extends through the hook from an opening 405 to another opening 410. The channel has a diameter that is sufficient to receive a length of the tether loop 105. As discussed above, means for attaching the tether loop 105 other than a channel may be provided without departing from the scope of the invention.

In FIGS. 11 through 13, an alternative exemplary hook 400 is illustrated. The hook 400 is attached to an end (e.g., the proximal end 110) of the tether loop 105. The hook 400 comprises a body configured to engage an edge of a saddle. The hook 400 generally resembles an L, with a pair of generally perpendicular legs 425, 430 with a terminal flange 420. A gap 415 is defined between the leg and flange 420, 425. The width of the gap 415 at the opening (i.e., the distance between the leg and flange 420, 425 at the opening) is greater than the thickness of the engaged edge of the saddle. Thus, the edge of the saddle may fit into the gap 415 of the hook. Such an edge is engaged by the hook 400 when the edge is within the gap 415.

A curved (e.g., U-shaped) channel extends through the hook from an opening 405 to another opening 410. The channel has a diameter that is sufficient to receive a length of the tether loop 105. As discussed above, means for attaching the tether loop 105 other than a channel may be provided without departing from the scope of the invention.

In FIGS. 11 through 13, an alternative exemplary hook 400 is illustrated. The hook 400 is attached to an end (e.g., the proximal end 110) of the tether loop 105. The hook 400 comprises a body configured to engage an edge of a saddle. The hook 400 generally resembles an L, with a pair of generally perpendicular legs 425, 430 with a terminal flange 420. A gap 415 is defined between the leg and flange 420, 425. The width of the gap 415 at the opening (i.e., the distance between the leg and flange 420, 425 at the opening) is greater than the thickness of the engaged edge of the saddle. Thus, the edge of the saddle may fit into the gap 415 of the hook. Such an edge is engaged by the hook 400 when the edge is within the gap 415.

A curved (e.g., U-shaped) channel extends through the hook from an opening 405 to another opening 410. The channel has a diameter that is sufficient to receive a length of the tether loop 105. As discussed above, means for attaching the tether loop 105 other than a channel may be provided without departing from the scope of the invention.

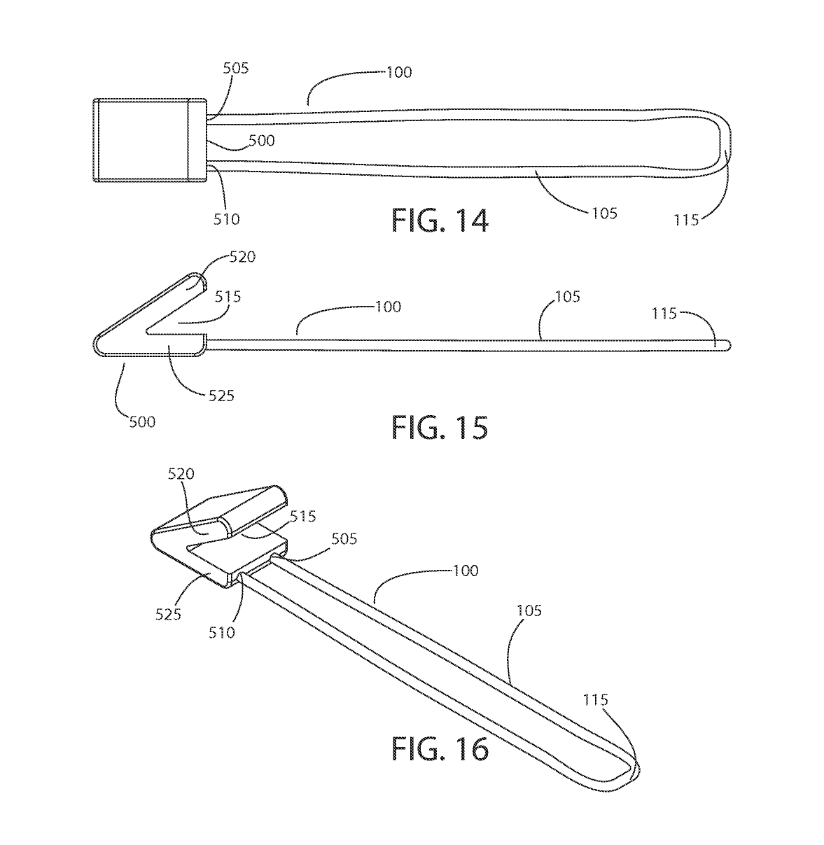

In FIGS. 14 through 16, an alternative exemplary hook 500 is illustrated. The hook 500 is attached to an end (e.g., the proximal end 110) of the tether loop 105. The hook 500 comprises a body configured to engage an edge of a saddle. The hook 500 generally resembles a V, with a pair of legs 520, 525 forming an acute angle. A gap 515 is defined between the legs 520, 525. The width of the gap 515 at the opening (i.e., the distance between the legs 520, 525 at the opening) is greater than the thickness of the engaged edge of the saddle. Thus, the edge of the saddle may fit into the gap 515 of the hook. Such an edge is engaged by the hook 500 when the edge is within the gap 515.

A curved (e.g., U-shaped) channel extends through the hook from an opening 505 to another opening 510. The channel has a diameter that is sufficient to receive a length of the tether loop 105. As discussed above, means for attaching the tether loop 105 other than a channel may be provided without departing from the scope of the invention.

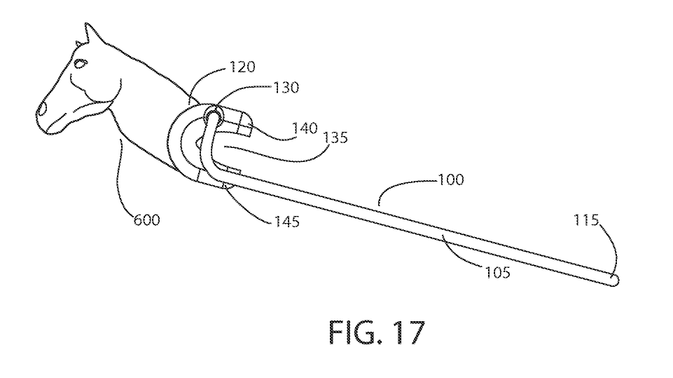

Referring now to FIG. 17, a side view of an exemplary saddle sling 100 with a decorative element 600 extending from the hook 120 is shown. Various ornamental and personalization features may be incorporated into or attached to the hook.

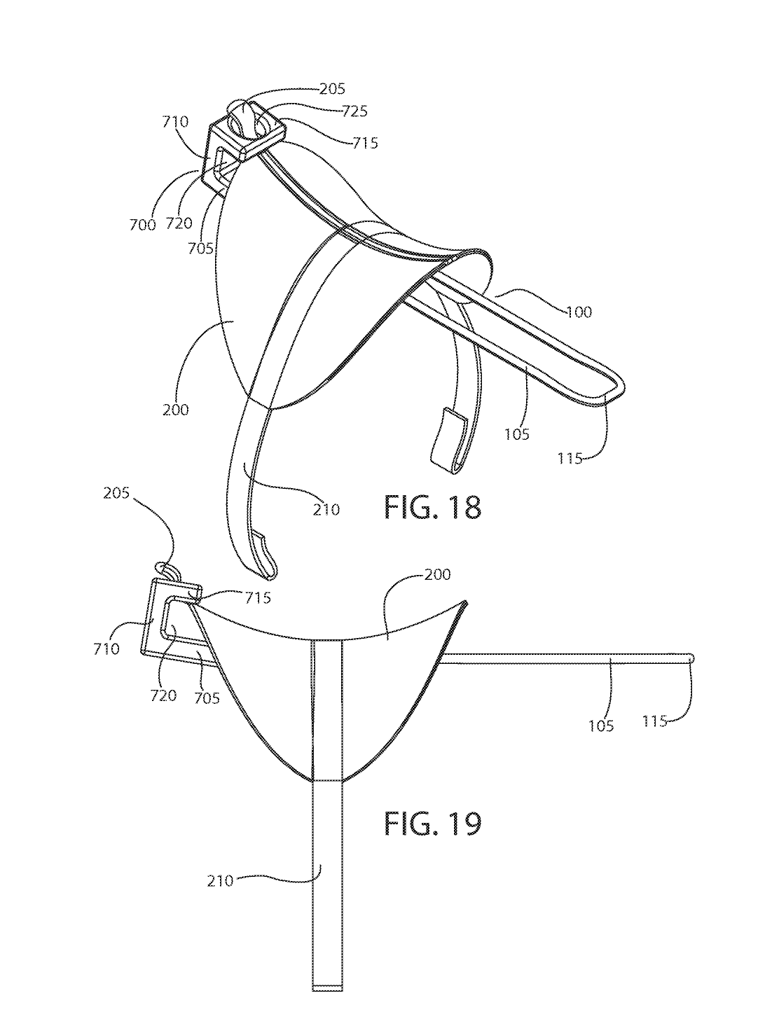

In FIGS. 18 and 19, an alternative exemplary hook 700 is illustrated on the sling 100. The hook 700 is attached to an end (e.g., the proximal end 110) of the tether loop 105. The hook 700 comprises a body configured to engage an edge of a saddle. In this embodiment, the hook engages the pommel, which is the front, slightly raised area of the saddle 200. The hook 700 generally resembles a C, with a pair of legs 705, 715 connected to a base 710, forming a C. A gap 720 is defined between the legs 705, 715. A horn opening 725 is sized and shaped to allow the horn at the pommel of the saddle 200 to extend therethrough. The width of the gap 720 at the opening (i.e., the distance between the legs 705, 715 at the opening) is greater than the thickness of the engaged edge of the saddle. Thus, the edge of the saddle may fit into the gap 720 of the hook, while the horn extends through the opening 725. Such an edge is engaged by the hook 700 when the edge is within the gap 720.

A curved (e.g., U-shaped) channel extends through the hook from an opening. The channel has a diameter that is sufficient to receive a length of the tether loop 105. As discussed above, means for attaching the tether loop 105 other than a channel may be provided without departing from the scope of the invention.

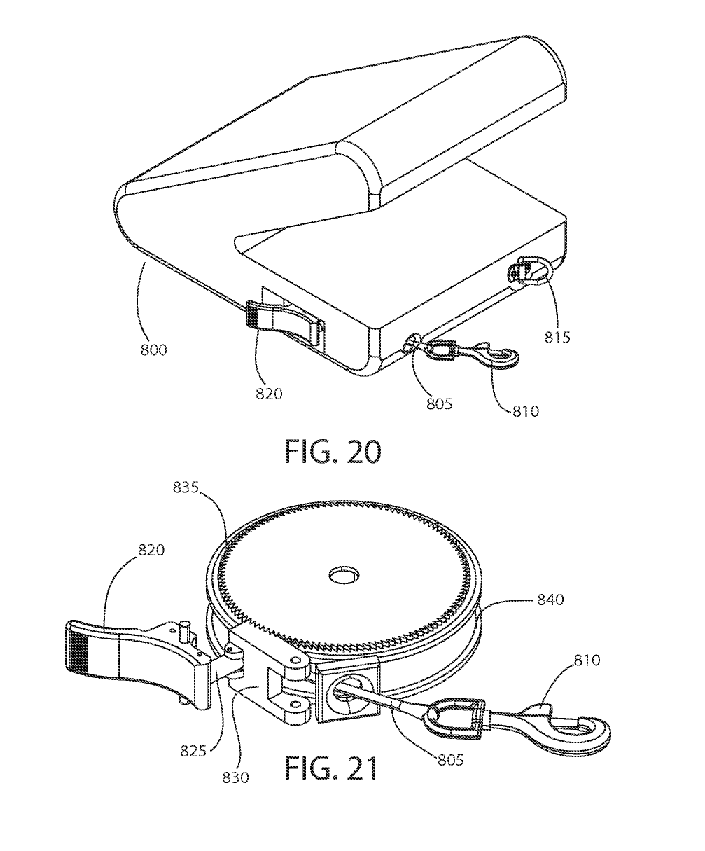

In yet another embodiment, the hook 800 contains a spring biased retractable spool of tether 805, as shown in FIGS. 20 and 21. The exemplary hook is shown as a V-shaped structure (as described above), though other shapes are feasible and come within the scope of this embodiment of the invention. A spring clip 810 may be attached to the distal end of the tether 805. A D-ring 815, or other means of attachment is provided for the extended tether to connect to form a loop for attachment to a fence as described above. A manual switch 820 urges or releases a pawl 830, which grips ratchet teeth or gear teeth 835 of a flywheel attached to the spool 840. Pressing the switch releases the pawl, which disengages from the toothed flywheel 835 and thereby allows the spool to spin. 840. A pivot pin 825 connects the switch 820 to the pawl 830. When the switch 820 releases the pawl 830, the spool 840 is spring biased to wind-up, i.e., retract, the tether 805. However, moderate pulling overcomes the retraction force. When the switch 820 is released and the pawl 830 engages the toothed flywheel 835, then the spool resists spinning in both the retracting and extending directions.

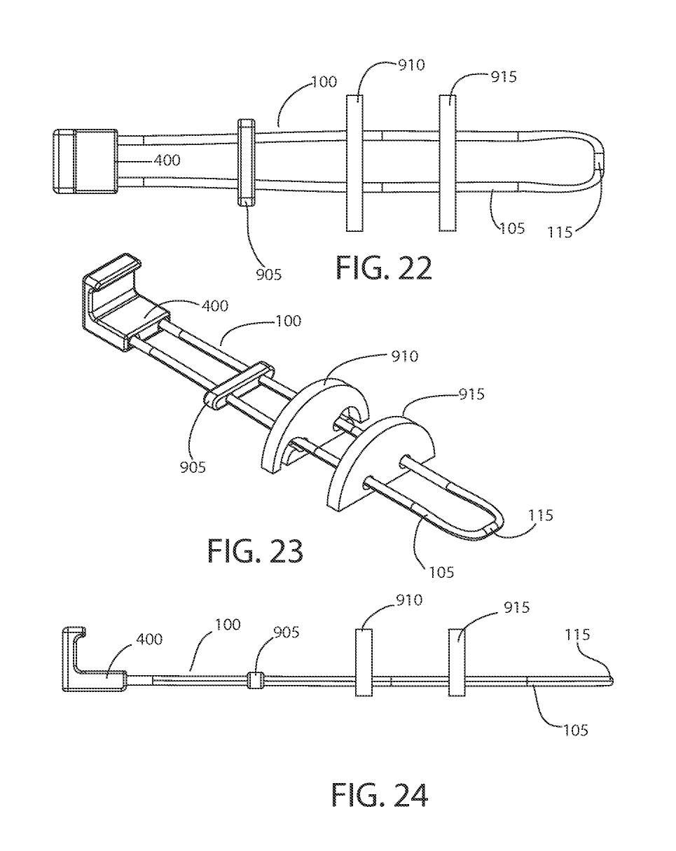

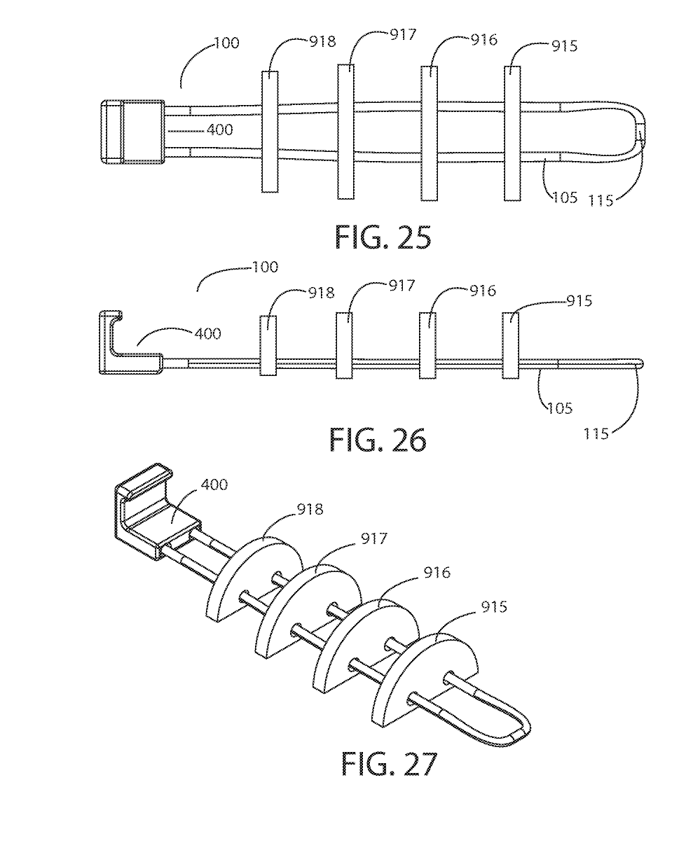

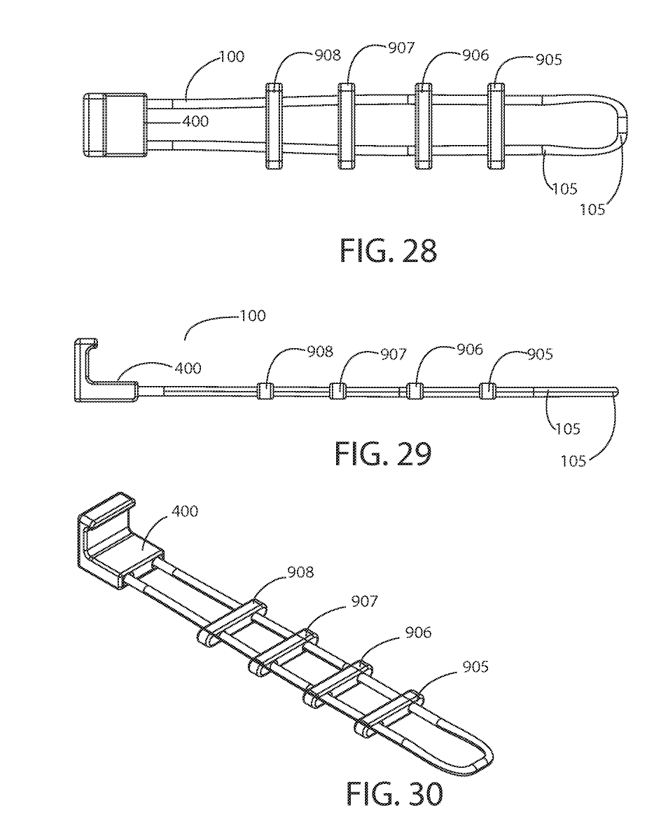

FIG. 22 through 30 show embodiments with saddle supports, which are support pieces that keep the tethers apart and help keep the curve in a saddle. Various supports are shown in FIGS. 22 through 24, including a prism 905, slip-on semi-circle 910 and thread-on semicircle 915. A slip on support may be slipped onto the tether without untying. A thread on support is installed before tying the tether. The number, shape, size and spacing of the supports may vary to accommodate a wide range of saddles. For example, the supports 915-918 in FIGS. 25 through 27 are semicircular and similarly sized. The supports 905-908 in FIGS. 28-30 are somewhat rectangular in cross section. When not in use the supports may slide down the tether of the saddle sling or be removed, and stored next to the saddle hook with the tether wrapping around it for easy and compact storage.

The supports may be comprised of any durable material that possesses the requisite structural properties for supporting a saddle and maintaining space between the ropes. Nonlimiting Examples include, metal, wood, plastic and composites.

While one or more exemplary embodiments of the invention have been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A saddle sling comprising:
a hook configured to engage an edge of one of a cantle and pommel of a saddle, said edge being an engaged edge of the saddle, said hook comprising a first segment that extends below the saddle at the engaged edge and a second segment that is attached to the first segment and extends above the engaged edge of the saddle, and
a tether loop extending from the hook, said loop having a proximal end attached to the hook and an opposite distal end, a distance from the proximal end and said distance being sufficient to allow the tether loop to pass under the saddle from the engaged edge to past the opposite edge by a sufficient additional distance for the distal end of the tether loop to slip over and engage a vertical support, and said tether loop being comprised of a flexible elongated structure.

2. The saddle sling of claim 1
said hook comprising a gap into which the engaged edge of the saddle is received.

3. The saddle sling of claim 1
said hook comprising a C-shaped body including a pair of spaced apart legs, each of said spaced apart legs having a free end and an opposite end, the opposite end of each of said spaced apart legs being attached to a connecting member, and a space defined between said spaced apart legs, and at the free ends of the spaced apart legs said space being wide enough to receive the engaged edge of the saddle, said first segment being one of the pair of spaced apart legs and said second segment being the connecting member.

4. The saddle sling of claim 1
said hook comprising a V-shaped body including a pair of diverging legs, each of said diverging legs having a free end and an opposite end, the opposite end of each of said diverging legs being attached together, and a space defined between said diverging legs, and at the free ends of the diverging legs said space being wide enough to receive the engaged edge of the saddle, said first segment being one of the pair of diverging legs and said second segment being the other of the pair of diverging legs.

5. The saddle sling of claim 1
said hook comprising a L-shaped body including a pair of orthogonal legs, each of said diverging legs having a free end and an opposite end, the opposite end of each of said orthogonal legs being attached together, and a space defined between said orthogonal legs, and at the free ends of the diverging legs said space being wide enough to receive the engaged edge of the saddle, said first segment being one of the pair of orthogonal legs and said second segment being the other of the pair of orthogonal legs.

6. The saddle sling of claim 1
said hook comprising a C-shaped body including a pair of spaced apart legs, each of said spaced apart legs having a free end and an opposite end, the opposite end of each of said spaced apart legs being attached to a connecting member, and a space defined between said spaced apart legs, and at the free ends of the spaced apart legs said space being wide enough to receive the engaged edge of the saddle, said first segment being one of the pair of spaced apart legs and said second segment being the connecting member, and one of the pair of spaced apart legs having an opening shaped and sized to receive a saddle horn.

7. The saddle sling of claim 1
said hook comprising a V-shaped body including a pair of diverging legs, each of said diverging legs having a free end and an opposite end, the opposite end of each of said diverging legs being attached together, and a space defined between said diverging legs, and at the free ends of the diverging legs said space being wide enough to receive the engaged edge of the saddle, said first segment being one of the pair of diverging legs and said second segment being the other of the pair of diverging legs, and one of the pair of diverging legs having an opening shaped and sized to receive a saddle horn.

8. The saddle sling of claim 1, said tether loop comprising a length of flexible tether from the group consisting of:
cordage,
filament,
cable,
chain and
rawhide.

9. The saddle sling of claim 1, further comprising a plurality of saddle supports, each saddle support extending from at least one section of the tether loop to an opposite section of the tether loop and maintaining a space therebetween and providing a support surface upon which the saddle may rest, said support surface maintaining a shape of the saddle.

10. The saddle sling of claim 1, said tether loop being extendable from and retractable into the hook.

11. The saddle sling of claim 10, said hook further comprising an interior compartment, said interior compartment housing a rotatable spool onto which a tether comprising the tether loop is wound.

12. The saddle sling of claim 11, said spool being spring biased to rotate the spool in direction to cause retraction of the tether comprising the tether loop.

13. The saddle sling of claim 12, a disc having a toothed outer edge attached concentrically to the spool and a user actuable pawl configured to engage the toothed outer edge and resist rotation when the pawl is not engaged and release the toothed outer edge and permit rotation when the pawl is released.

14. The saddle sling of claim 13, a manual switch operably coupled to the pawl, said manual switch extending outwardly from the hook and being manually actuated by a user, said manual switch causing release of the pawl when the manual switch is actuated and allowing the pawl to engage the toothed outer edge when the manual switch is not actuated.

15. The saddle sling of claim 1, further comprising a fence post having a free upper end, over which the distal end of the tether loop is slipped, and said distal end of the tether loop engaging the free upper end of the fence post.

16. The saddle sling of claim 15, said fence post being a part of a fence.

17. The saddle sling of claim 16, further comprising a saddle with a pommel and an edge at the pommel engaged by the hook, and said sling supporting the saddle between the fence post and the hook.

18. The saddle sling of claim 16, further comprising a saddle with a pommel and an edge at the pommel engaged by the hook, and said sling supporting the saddle between the fence and the hook.

19. The saddle sling of claim 16, further comprising a saddle with a cantle and an edge at the cantle engaged by the hook, and said sling supporting the saddle between the fence post and the hook.

20. The saddle sling of claim 1, further comprising an ornament attached to the hook.
